(19) United States
(12) Patent Application Publication
(10) Pub. No.: US 2026/0340915 A1
(43) Pub. Date: Oct. 29, 2026

(54) GENERALIZABLE DIFFUSION MODEL FOR POSITRON EMISSION TOMOGRAPHY IMAGE ENHANCEMENT

(71) Applicant: UNIVERSITY OF MASSACHUSETTS, Westborough, MA (US)

(72) Inventors: Joyita DUTTA, Westborough, MA (US); Tzu-An SONG, Westborough, MA (US); Ziyuan ZHOU, Westborough, MA (US)

(21) Appl. No.: 19/656,179

(22) Filed: Apr. 23, 2026

Related U.S. Application Data
(60) Provisional application No. 63/793,469, filed on Apr. 23, 2025.

(51) Int. Cl. G06T 12/30; G06T 7/00

(52) U.S. Cl. CPC G06T 12/30; G06T 7/97; G06T 2207/10104; G06T 2207/20081

(57) ABSTRACT

An exemplary system and method are disclosed for generating higher-resolution/higher-quality images (e.g., super-resolution positron emission tomography (PET) images) from a lower-resolution or quality image scan using an artificial intelligence (AI) model topology comprising a diffusion model configured with a separate cross-domain model front end.

### RELATED APPLICATION

This application claims priority to, and the benefit of, U.S. Provisional Patent Application No. 63/793,469, filed Apr. 23, 2025, entitled “GENERALIZABLE DIFFUSION MODEL FOR POSITRON EMISSION TOMOGRAPHY IMAGE ENHANCEMENT,” which is incorporated by reference herein in its entirety.

### GOVERNMENT SPONSORSHIP CLAUSE

This invention was made with government support under grant numbers R03AG070750 and R01AG072669, awarded by the National Institutes of Health (NIH). The government has certain rights in the invention.

### BACKGROUND

Positron emission tomography (PET) is a molecular imaging method for diagnosing and treating diseases such as Alzheimer's disease and cancer. High-quality PET scans require advanced scanners (which are expensive), high-dose radioactive tracer injections (which increase patient radiation exposure), and a long scan period (which can cause patient discomfort). On the other hand, low-quality PET images, while being potentially lower cost to acquire (using legacy scanners with significantly lower spatial resolution, low-dose injections, or short scan durations), can hinder diagnostic accuracy and quantification.

There is a benefit to improving the PET imaging systems.

### SUMMARY

An exemplary system and method are disclosed for generating higher-resolution/higher-quality images (e.g., super-resolution positron emission tomography (PET) images) from a lower-resolution or lower-quality image scan using an artificial intelligence (AI) model topology comprising a diffusion model with a separate cross-domain model front-end. The exemplary system and method can leverage a pre-trained diffusion model as a prior to inverse uniform degradation processes such as Gaussian blur. By integrating cross-domain model with cross-domain loss, the exemplary system and method can provide an aligned latent space that enables transfer of image learning between an unknown low-resolution dataset and an inverse uniform-degradation dataset (e.g., a Gaussian blur dataset) for effective posterior sampling.

Tomography imaging systems used for neurodegenerative disease research and other medical fields offer a range of resolutions, and many legacy scanner models remain in active clinical use. PET images generated by these imaging systems can have limited spatial resolution, hindering the quantification and diagnosis of brain diseases or conditions. To address this issue, previous studies developed super-resolution (SR) methods for PET relying on supervised learning. However, these current state-of-the-art SR methods, in some examples, require paired low- (LR) and high-resolution (HR) images for model training, posing a limitation in medical scenarios where paired datasets are unavailable. Previous studies also developed deep generative models to generate high-quality images using unsupervised data [1], [2]. Diffusion models have also been explored for PET SR [3], but these models still rely on paired LR and HR images. To acquire a paired dataset, the same patient would have to be contemporaneously scanned by two scanners of different types.

By employing a generalizable trained AI model having both a separate cross-domain model front-end and a diffusion model trained on unpaired data to generate paired low-resolution and high-resolution images via an inverse uniform degradation process as described herein, the exemplary system can generate high-resolution images from low-resolution/standard data. The training can also use paired data, if available, though it is not necessary. The exemplary generalizable trained AI model can have broad applications in legacy PET scanners, low-dose injection PET imaging, and short-scan-duration PET imaging, among others. The cross-domain model and diffusion model can also be trained separately.

In an aspect, a system for generating a tomography image of a patient is disclosed comprising: a controller including: a processor; and a memory having instructions stored thereon for a trained AI model including a diffusion model and a cross-domain model (e.g., cross-domain autoencoder), wherein execution of the instructions causes the processor to: receive, via the processor, a tomography image acquired from a first type of scanner; and apply, via the processor, the received image to the trained AI model including the diffusion model and the cross-domain model to generate an output image having image resolution, quality, or scan configuration exceeding that of the received tomography image, wherein the cross-domain model was trained using a first set of training data, including (i) a set of baseline tomography images acquired from the first type of scanner and (ii) a second set of tomography images derived from a spatially uniform degradation process applied to a high-resolution tomography images acquired from a second type of scanner, wherein the second type of scanner has higher image resolution, image quality, or scan configuration than the first type of scanner, and wherein the diffusion model was separately trained using an unpaired set of high-resolution tomography images as a second set of training data.

In some embodiments, the trained AI model was trained with (i) the set of baseline tomography images being applied to the cross-domain model, (ii) the unpaired set of high-resolution tomography images being applied to the cross-domain model and the diffusion model through a spatially uniform degradation process to provide simulated baseline tomography images as training data to the cross-domain model and the diffusion model.

In some embodiments, the cross-domain model is a cross-domain autoencoder comprising: an encoder configured to receive the set of tomography images acquired from the first type of scanner and the set of tomography images acquired from the second type of scanner as inputs; and two or more decoders coupled to the encoder and configured to be separately trained for reconstruction loss and adversarial loss, each decoder being configured to reconstruct the received inputs from the respective first and second types of scanners.

In some embodiments, the tomography image is selected from a group consisting of a positron emission tomography (PET) image, an ultrasound image, a magnetic resonance image (MRI), an X-ray image, and an image with spatial variations in resolution.

In some embodiments, the diffusion model was trained using a pre-trained diffusion model via (i) a forward process that gradually adds noise to a clean image until it becomes pure Gaussian noise and (ii) a reverse sampling process that reverses the forward process to generate clean images from pure noise, the pre-trained diffusion model being regularized with a diffusion posterior sampling (DPS) score function.

In some embodiments, for cross-domain model training, an original standard image dataset and a degraded high-quality image dataset are both employed so the cross-domain model aligns a standard image domain and a high-quality image domain.

In some embodiments, for diffusion model training, an original high-quality image dataset and a corresponding paired degraded image dataset are employed.

In another aspect, a non-transitory computer-readable medium having instructions stored thereon is disclosed, wherein execution of the instructions by a processor causes the processor to: receive, via the processor, a tomography image acquired from a first type of scanner; and apply, via the processor, the received image to a trained AI model including a diffusion model and a cross-domain model to generate an output image having image resolution, quality, or scan configuration exceeding that of the received tomography image, wherein the cross-domain model was trained using a first set of training data, including (i) a set of baseline tomography images acquired from the first type of scanner and (ii) a second set of tomography images derived from a spatially uniform degradation process applied to a high-resolution tomography images acquired from a second type of scanner, wherein the second type of scanner has higher image resolution, image quality, or scan configuration than the first type of scanner, and wherein the diffusion model was separately trained using an unpaired set of high-resolution tomography images as a second set of training data

In some embodiments, the trained AI model was trained with (i) the set of baseline tomography images being applied to the cross-domain model, (ii) the unpaired set of high-resolution tomography images being applied to the cross-domain model and the diffusion model through a spatially uniform degradation process to provide simulated baseline tomography images as training data to the cross-domain model and the diffusion model.

In some embodiments, the cross-domain model is a cross-domain autoencoder comprising: an encoder configured to receive the set of tomography images acquired from the first type of scanner and the set of tomography images acquired from the second type of scanner as inputs; and two or more decoders coupled to the encoder and configured to be separately trained for reconstruction loss and adversarial loss, each decoder being configured to reconstruct the received inputs from the respective first and second types of scanners.

In some embodiments, the tomography image is selected from a group consisting of a positron emission tomography (PET) image, an ultrasound image, a magnetic resonance image (MRI), an X-ray image, and an image with spatial variations in resolution.

In some embodiments, the diffusion model was trained using a pre-trained diffusion model via (i) a forward process that gradually adds noise to a clean image until it becomes pure Gaussian noise and (ii) a reverse sampling process that reverses the forward process to generate clean images from pure noise, the pre-trained diffusion model being regularized with a diffusion posterior sampling (DPS) score function.

In some embodiments, for cross-domain model training, an original standard image dataset and a degraded high-quality image dataset are both employed so the cross-domain model aligns a standard image domain and a high-quality image domain.

In some embodiments, for diffusion model training, an original high-quality image dataset and a corresponding paired degraded image dataset are employed.

In yet another aspect, a method for training an AI model including a diffusion model and a cross-domain model is disclosed comprising: training the cross-domain model using (i) a set of baseline tomography images being applied to the cross-domain model and (ii) an unpaired set of high-resolution tomography images being applied to the cross-domain model through a spatially uniform degradation process; and training the diffusion model, wherein the diffusion model was separately trained using the unpaired set of high-resolution tomography images applied to the diffusion model through the spatially uniform degradation process.

In some embodiments, the trained AI model was trained with (i) the set of baseline tomography images being applied to the cross-domain model, (ii) the unpaired set of high-resolution tomography images being applied to the cross-domain model and the diffusion model through a spatially uniform degradation process to provide simulated baseline tomography images as training data to the cross-domain model and the diffusion model.

In some embodiments, the cross-domain model is a cross-domain autoencoder comprising: an encoder configured to receive the set of tomography images acquired from a first type of scanner and the set of tomography images acquired from a second type of scanner as inputs; and two or more decoders coupled to the encoder and configured to be separately trained for reconstruction loss and adversarial loss, each decoder being configured to reconstruct the received inputs from the respective first and second types of scanners.

In some embodiments, each tomography image is selected from a group consisting of a positron emission tomography (PET) image, an ultrasound image, a magnetic resonance image (MRI), an X-ray image, and an image with spatial variations in resolution.

In some embodiments, the diffusion model was trained using a pre-trained diffusion model via (i) a forward process that gradually adds noise to a clean image until it becomes pure Gaussian noise and (ii) a reverse sampling process that reverses the forward process to generate clean images from pure noise, the pre-trained diffusion model being regularized with a diffusion posterior sampling (DPS) score function.

In some embodiments, for cross-domain model training, an original standard image dataset and a degraded high-quality image dataset are both employed so the cross-domain model aligns a standard image domain and a high-quality image domain.

### BRIEF DESCRIPTION OF DRAWINGS

FIGS. 1A and 1B each show an example system having a generalizable trained artificial intelligence (AI) model configured to generate a super-resolution tomography image using a standard tomography image of a patient, in accordance with an illustrative embodiment.

FIG. 2 shows an example method of training a generalizable trained AI model comprising a diffusion model and a cross-domain model, in accordance with an illustrative embodiment.

FIG. 3A shows an example generalizable trained AI model having a diffusion probabilistic model (DPM) with diffusion posterior sampling and a cross-domain network to enable data-consistent super-resolution (SR) without paired high-resolution-low-resolution (HR-LR) training data, in accordance with an illustrative embodiment.

FIG. 3B shows an example cross-domain network configured for unsupervised LR domain transfer in the exemplary system, in accordance with an illustrative embodiment.

FIG. 3C shows an example algorithmic implementation of a cross-domain diffusion posterior sampling (CD-DPS) process in the exemplary system, in accordance with an illustrative embodiment.

FIGS. 4A-4D show the evaluation results for the generalizable trained AI model (see FIGS. 1 and 3) and the baseline models for positron emission tomography (PET) imaging.

FIGS. 5A-5D each show an example system having a generalizable trained artificial intelligence (AI) model configured to generate a super-resolution or improved image using an initial image acquired from a legacy scanner, in accordance with an illustrative embodiment.

FIGS. 6A-6E each show an example system having a generalizable trained artificial intelligence (AI) model configured to generate an improved image using cross-domain training from another modality, in accordance with an illustrative embodiment.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

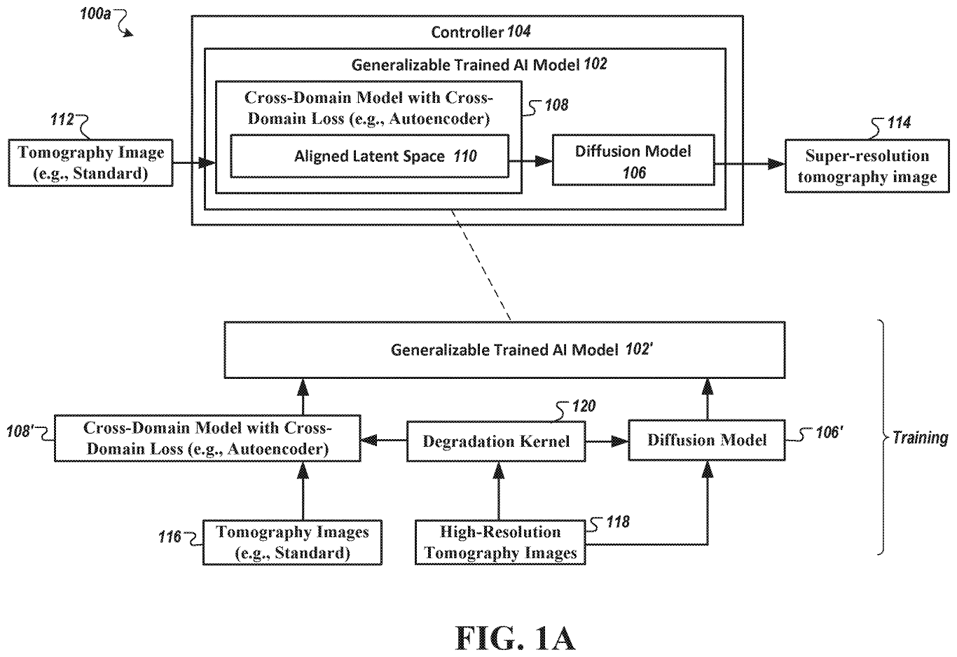

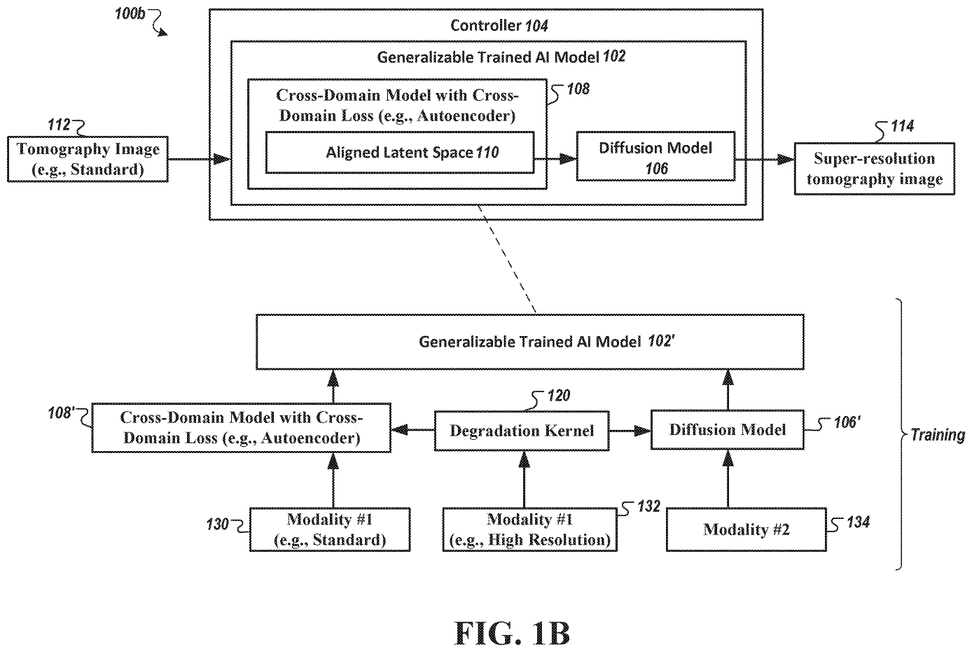

FIGS. 1A and 1B each shows an example system 100 (shown as 100a, 100b) having a generalizable trained artificial intelligence (AI) model 102 (shown as 102′) (e.g., implemented on a controller 104) configured to generate a super-resolution tomography image 114 using a standard tomography image 112 (e.g., of a brain) of a patient, in accordance with an illustrative embodiment. The generalizable trained AI model 102 includes a diffusion model 106 (shown as 106′) and a separate cross-domain model with cross-domain/self-supervised loss 108 (shown as 108′), where the cross-domain model 108 aligns the latent spaces 110 of standard tomography images and synthetic low-quality tomography images derived from the target high-resolution tomography images 114. A cross-domain model is deep learning framework that maps data from different domains into a shared latent and can include autoencoders, adversarial autoencoders, variational autoencoders, coupled architectures, among others.

In the example shown in FIG. 1A, the exemplary system 100a receives a standard tomography image 112 acquired from a first type of scanner (e.g., a PET scanner, X-ray scanner, ultrasound scanner, etc.). The terms “baseline tomography image” or “standard tomography image” refer to scanned images from legacy scanners, low-dose injections, short scan durations, or some baseline scan which can be improved to (i) higher-quality or higher-resolution PET scans, e.g., analogous to those acquired by advanced scanners, (ii) high-dose injections of radioactive tracers, and (iii) longer scan period. The exemplary system 100a then applies the received image 112 to the trained AI model 102 to generate an output image 114 with a higher resolution, quality, or scan configuration (e.g., a super-resolution tomography image) than the received tomography image 112. The output image 114 can subsequently be used for further monitoring or diagnosis of a brain condition or disease of the patient. The baseline tomography image 112 and the super-resolution tomography image 114 should be of the same type, such as a PET, X-ray, ultrasound, or magnetic resonance (MRI) image, or an image with spatially varying resolution.

In some embodiments, the cross-domain model 108 is a cross-domain autoencoder having (i) an encoder (e.g., 310) configured to receive the set of tomography images (e.g., 116) acquired from the first type of scanner and the set of tomography images (e.g., 118) acquired from a second type of scanner as inputs, and (ii) two or more decoders (e.g., 312a, 312b), coupled to the encoder, each decoder configured to reconstruct the received inputs (e.g., 116, 118) from the respective first and second types of scanners. In some embodiments, each decoder is configured to be separately trained on reconstruction and adversarial losses.

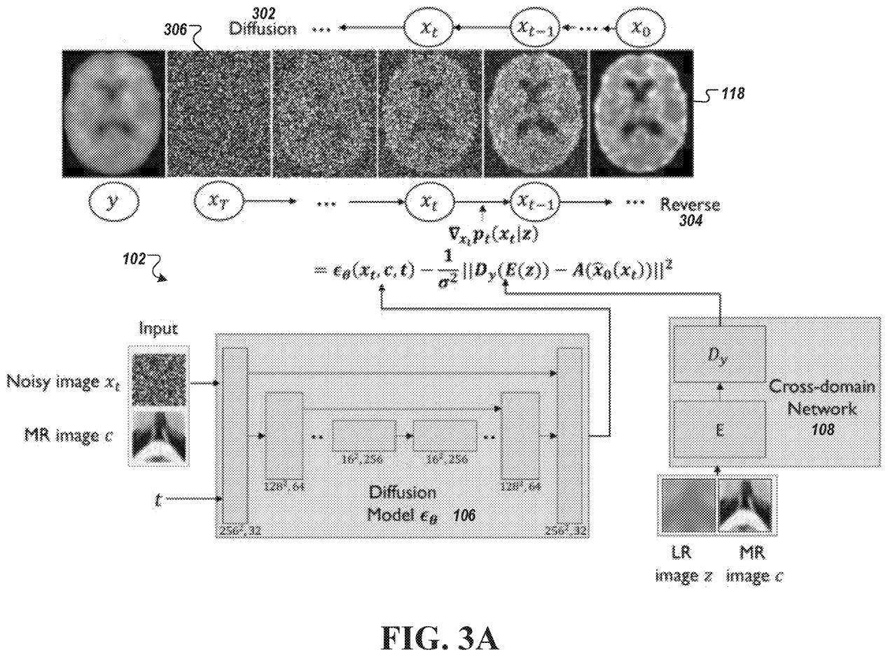

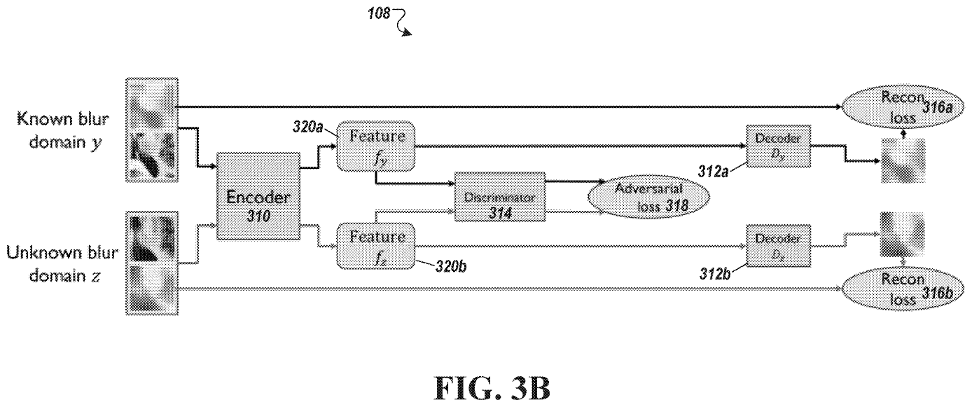

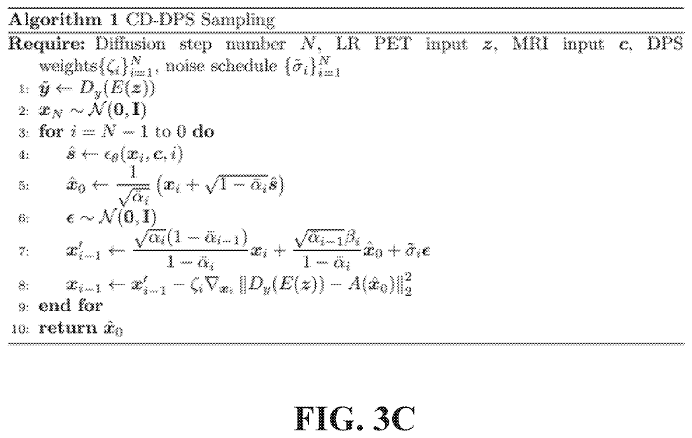

Generalizable Trained AI Model. In the example shown in FIG. 1A, the generalizable trained AI model 102 employs a combination module comprising a cross-domain model with cross-domain/self-supervised loss 108 and a diffusion model 106 that is configured to receive the tomography image 112 and generate a super-resolution image 114. The cross-domain model 108 and the diffusion model 106 can be trained, in part, by the same training system, but in separate training processes. The cross-domain model 108 can be trained using (i) a first set of training data, including a set of tomography images 116 acquired from the first type of scanner (e.g., baseline/standard data) for the cross-domain model training and (ii) a set of tomography images 118 acquired from a second type of scanner (high-resolution data) for the cross-domain model and the diffusion model training. As shown in FIG. 1A, the baseline/standard data 116 is used for cross-domain model training, and the unpaired high-resolution data 118 is used for both the cross-domain model and the diffusion model training via a spatially uniform degradation kernel/process/filter 120 (e.g., a Gaussian blur filter). An example of the training process for the cross-domain model (e.g., 108) using the baseline/standard data and the degraded high-resolution data is further shown in FIG. 3B.

The diffusion model 106 can be separately trained using the same unpaired high-resolution training image 118, from which paired high-resolution and low-resolution images can be generated using the spatially uniform degradation kernel 120 (e.g., a Gaussian blur filter) and provided to the diffusion model and the cross-domain model training.

The diffusion model 106 or the cross-domain model 108 can be trained with either the diffusion model 106 being trained first and the cross-domain model 108 second, or vice versa. That is, the sequence can be (i) the diffusion model 106, then the cross-domain model 108, or (ii) the cross-domain model 108, then the diffusion model 106. For cross-domain model training, both standard (low-quality) data and degraded high-quality data are used so the cross-domain model 108 can align the two low-quality domains. For diffusion training, only the original high-quality data and the corresponding paired degraded data are used, so the diffusion model 106 can perform SR or quality enhancement based on the known degradation process 120.

After training the cross-domain model 108 and diffusion model 106, the generalizable trained AI model 102, with the trained cross-domain model 108 and diffusion model 106, is configured to generate super-resolution tomography images 114 from an input standard tomography image 112.

The above-discussed first and second types of scanners can be PET scanners, ultrasound scanners, MRI scanners, or X-ray scanners.

In the example shown in FIG. 1B, the cross-domain model 108 can be trained directly by (i) a first imaging modality with baseline resolution 130 (shown as modality #1 (e.g., standard)), or tomography images thereof, and (ii) the same first imaging modality with high resolution 132 (shown as modality #1 (e.g., high resolution)), or degraded tomography images thereof that is degraded by the degradation kernel 120. The diffusion model 106 can be trained (i) directly by the second imaging modality 134.

### Example Method

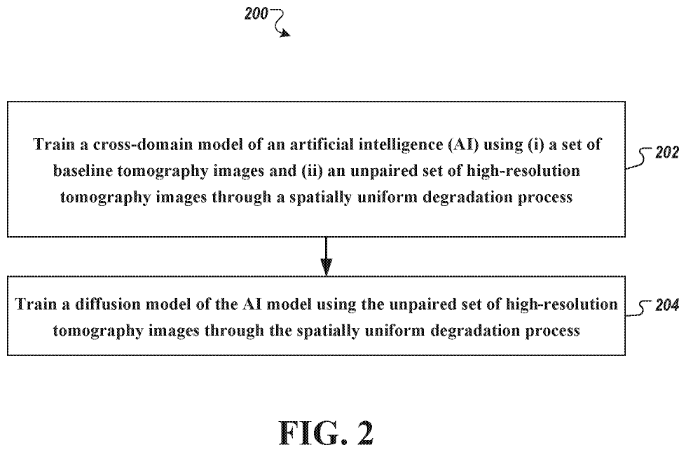

FIG. 2 shows an example method 200 for training a generalizable trained AI model (e.g., 102) comprising a diffusion model (e.g., 106) and a cross-domain model with cross-domain/self-supervised loss (e.g., 108), in accordance with an illustrative embodiment. The method 200 includes training (202) the cross-domain model (e.g., 108) using (i) a set of baseline tomography images (e.g., 116) being applied to the cross-domain model (e.g., 108) and (ii) an unpaired set of high-resolution tomography images (e.g., 118) being applied to the cross-domain model (e.g., 108) through a spatially uniform degradation process (e.g., 120).

In some embodiments, each tomography image is selected from a group consisting of a positron emission tomography (PET) image, an ultrasound image, a magnetic resonance image (MRI), an X-ray image, and an image with spatial variations in resolution.

The method 200 includes training (204) the diffusion model (e.g., 106) separately using the unpaired set of high-resolution tomography images (e.g., 118) applied to the diffusion model (e.g., 106) through the spatially uniform degradation process (e.g., 120).

In some embodiments, the cross-domain model (e.g., 108) includes (i) an encoder (e.g., 310) configured to receive the set of tomography images (e.g., 116) acquired from a first type of scanner and the set of tomography images (e.g., 118) acquired from a second type of scanner as inputs, and (ii) two or more decoders (e.g., 312a, 312b), coupled to the encoder, each decoder configured to reconstruct the received inputs (e.g., 116, 118) from the respective first and second types of scanners. In some embodiments, each decoder is configured to be separately trained on reconstruction and adversarial losses.

In some embodiments, the diffusion model (e.g., 106) was trained using a pre-trained diffusion model via (i) a forward process that gradually adds noise to a clean image until it becomes pure Gaussian noise and (ii) a reverse sampling process that reverses the forward process to generate clean images from pure noise, the pre-trained diffusion model being regularized with a diffusion posterior sampling (DPS) score function.

In some embodiments, for cross-domain model training, an original standard image dataset and a degraded high-quality image dataset are employed so the cross-domain model (e.g., 108) can align a standard image domain and a high-quality image domain.

### Example Implementation

FIG. 3A shows an example generalizable trained AI model 102 having a diffusion probabilistic model (DPM) 106 with diffusion posterior sampling and a cross-domain network 108 (also referred to as a cross-domain model) to enable data-consistent super-resolution (SR) without paired high-resolution-low-resolution (HR-LR) training data, in accordance with an illustrative embodiment.

The generalizable trained AI model 102, also referred to as the cross-domain diffusion posterior sampling (CD-DPS) model, is configured to break a hard unsupervised SR task into three parts: (i) HR PET image generation, (ii) SR through data consistency constraint using LR PET, and (iii) domain transfer between LR domains. In the trained AI model 102, the DPM 106 can generate high-quality PET images (e.g., 114), the diffusion posterior sampling (DPS) can enable SR for various degradation kernels (e.g., 120) (e.g., Gaussian blur filter), and the cross-domain network 108 can map the unknown LR domain from real-world LR PET images to the known LR domain, given a degradation kernel 120 (e.g., Gaussian blur filter).

Diffusion Probabilistic Model (DPM). In FIG. 3A, the trained AI model 102 is built on the DPM 106 as a generative backbone to produce high-quality HR PET images (e.g., 114). The DPM 106 can model a target data distribution by constructing a stochastic forward process 302 (shown as a diffusion process) and generating data samples from the distribution by iteratively solving the reverse process 304. Considering x₀~q(x₀) as the desired data distribution, i.e., target HR PET images 118 (denoted as x₀), the forward process 302 can add Gaussian noise (e.g., via 120) to x₀ until it is corrupted (see 306). Given a noise schedule (denoted as β_{1, . . . , T}∈[0, 1)) and a total diffusion step (denoted as T), the forward process 302 can be defined per Equation 1.

$$q ( {x}_{1 : T} \vert {x}_{0} ) = {\prod }_{t = 1}^{T} q ( {x}_{t} \vert {x}_{t - 1} ) , q ( {x}_{t} \vert {x}_{t - 1} ) = N ( {x}_{t} ; \sqrt{1 - {β}_{t}} {x}_{t - 1} , {β}_{t} I ) \qquad ( Eq . 1 )$$

In Equation 1, x₀ denotes a clean HR PET image 118 sampled from the target data distribution, and xₜ denotes an image 306 obtained by corrupting x₀ with Gaussian noise after t diffusion steps. As t increases, xₜ becomes noisier. At the final step T, x_{T}≈N(0, I), which is pure noise (see 306). By reparameterizing the noise schedule by αₜ=1−βₜ and

$${\overline{α}}_{t} = {\prod }_{s = 0}^{t} {α}_{s} ,$$

the image xₜ can be sampled at any timestep t without the need to iterate from x₀, as shown in Equation 2.

q(xₜ|x₀)=N(xₜ;\sqrt{α̅ₜ}x₀,(1−α̅ₜ)I) (Eq. 2)

With a proper noise schedule, x_{T} can converge to an isotropic Gaussian distribution. Thus, the reverse process 304 can start from a sample x_{T}~N(0, I) and solve p(xₜ₋₁|xₜ, x₀) iteratively. Since x₀ is not trackable during the sampling process, a neural network (denoted as ϵ_{θ}) with trainable parameters θ can be utilized to predict a learned reverse diffusion transition probability (denoted as p_{θ}(xₜ₋₁|xₜ)) without the need for explicit knowledge on x₀, as shown in Equation 3.

$${p}_{θ} ( {x}_{t - 1} \vert {x}_{t} ) = N ( {x}_{t - 1} ; {μ}_{θ} ( {x}_{t} , t ) {σ}_{t}^{2} I ) \qquad ( Eq . 3 )$$

In Equation 3, μ_{θ}(xₜ, t) is the best estimate of the latent image xₜ₋₁ given the noisy image xₜ at the diffusion step t, which can be defined per Equation 4.

$${μ}_{θ} ( {x}_{t} , t ) = \frac{1}{\sqrt{{α}_{t}}} ( {x}_{t} - \frac{1 - {α}_{t}}{\sqrt{1 - {\overline{α}}_{t}}} {ϵ}_{θ} ( {x}_{t} , t ) ) \qquad ( Eq . 4 )$$

In Equation 4, ϵ_{θ} (e.g., 106) can take extra inputs as conditions to model the conditional reverse distribution. Co-registered magnetic resonance (MR) images can be used as a conditional input c, enabling the DPM 106 to be trained as a conditional model that learns the MR-guided reverse diffusion distribution, as shown in Equation 5.

$${p}_{θ} ( {x}_{t - 1} \vert {x}_{t} , c ) = N ( {x}_{t - 1} ; {μ}_{θ} ( {x}_{t} , c , t ) {σ}_{t}^{2} I ) \qquad ( Eq . 5 )$$

The neural network ϵ_{θ} (e.g., 106) can be trained to minimize the difference between the network output and the actual noise ϵ used to obtain xₜ, as shown in Equation 6.

$${∇}_{θ} {‖ ϵ - {ϵ}_{θ} ( \sqrt{{\overline{α}}_{t}} {x}_{0} + ϵ \sqrt{1 - {\overline{α}}_{t}} , c , t ) ‖}_{2}^{2} \qquad ( Eq . 6 )$$

In Equation 6, ϵ_{θ} can capture the score function ∇ₓ_{ₜ} log p(xₜ) of the target data distribution p(x₀), which can be defined as the gradient of the log-likelihood.

Diffusion Posterior Sampling (DPS). In a super-resolution (SR) task, a low-resolution (LR) observation (denoted as y) of the high-resolution (HR) ground truth (denoted as x₀) may be available, where the image degradation process (e.g., 120) (e.g., Gaussian blur filter) can be modeled per Equation 7.

y=A(x₀)+n (Eq. 7)

In Equation 7, y, n, x₀∈R^{d}, A(⋅):R^{d}→R^{d} denotes a degradation kernel (e.g., 120), and n denotes the measurement noise that follows a Gaussian distribution with variance σ². The DPS can then formulate the SR task as an inverse problem by modeling the posterior score of the diffused HR image xₜ conditioned on the LR observation y, as shown in Equation 8.

∇ₓ_{ₜ} log pₜ(xₜ|y)=∇ₓ_{ₜ} log pₜ(xₜ)+∇ₓ_{ₜ} log pₜ(y|xₜ) (Eq. 8)

In Equation 8, the first distribution term, ∇ₓ_{ₜ} log pₜ (xₜ), can be generated by the DPM backbone, as shown in Equation 9.

∇ₓ_{ₜ} log pₜ(xₜ)=ϵ_{θ}(xₜ,c,t) (Eq. 9)

In Equation 8, the second distribution term, ∇ₓ_{ₜ} log pₜ (y|xₜ), is only known at time point t=0 (e.g., ∇ₓ_{₀} log pₜ (y|x₀)), given the degradation process (e.g., 120) (e.g., Gaussian blur filter), but not at a non-zero time point. Using the score function predicted by DPM, ∇ₓ_{ₜ} log pₜ (y|xₜ) can be estimated per Equation 10.

$${∇}_{{x}_{t}} log {p}_{t} ( y \vert {x}_{t} ) ≃ {∇}_{{x}_{0}} log {p}_{t} ( y \vert {\hat{x}}_{0} ) \qquad ( Eq . 10 )$$

$$where , {\hat{x}}_{0} ( {x}_{t} ) ≃ \frac{1}{\sqrt{\overline{α} ( t )}} ( {x}_{t} + ( 1 - \overline{α} ( t ) ) {ϵ}_{θ} ( {x}_{t} , c , t ) ) \qquad ( Eq . 11 )$$

By substituting Equation 11 into Equation 8 and using the Gaussian framework, the DPS score function can be defined per Equation 12.

$${∇}_{{x}_{t}} log {p}_{t} ( {x}_{t} \vert y ) ≃ {ϵ}_{θ} ( {x}_{t} , c , t ) - \frac{1}{{σ}^{2}} {∇}_{{x}_{t}} {‖ y - A ( {\hat{x}}_{0} ( {x}_{t} ) ) ‖}_{2}^{2} \qquad ( Eq . 12 )$$

By adjusting the scale factor, the DPS can tune the relative influence of the diffusion prior and the data-consistency term during generation. Another feature of DPS is the flexibility to apply the same DPM backbone across various degradation kernels, enabling selection of an appropriate kernel for the LR-domain transfer process.

Cross-Domain Network. FIG. 3B shows an example cross-domain network 108 configured for unsupervised LR domain transfer, in accordance with an illustrative embodiment.

Although DPS can produce high-quality SR images (e.g., 114) for varying degradation kernels (e.g., 120), it cannot be directly used for real-world LR PET images where the degradation kernel A(⋅) is unknown. The cross-domain network 108 (also referred to as the LR domain transfer network), configured with domain adaptation, is configured to convert real-world LR PET images into known LR PET images obtained by A(⋅). A degradation kernel A(⋅) (e.g., 120) (e.g., Gaussian blur filter) can be selected to generate an LR PET dataset with high visual similarity with the real-world LR PET. For any new dataset, only selecting the degradation kernel A(⋅) and fine-tuning the cross-domain network 108 are required, rather than retraining the entire SR framework, as in most SR models.

In FIG. 3B, the cross-domain network 108 includes a shared encoder 310 (denoted as E), two decoders 312a and 312b (denoted as D_{y} and D_{z}), and a discriminator 314 (denoted as Dis). Given unpaired data samples from the known LR domain (denoted as y=A(x)) and the unknown LR domain (denoted as z), the encoder 310 and decoders 312a-312b can be trained by the combination of a reconstruction loss 316a-316b (denoted as L_{rec}) and an adversarial loss 318 (denoted as L_{adv}). The reconstruction loss L_{rec} (e.g., 316a, 316b) and the adversarial loss L_{adv} (e.g., 318) can be defined per Equations 13 and 14, respectively.

$${L}_{rec} = {‖ y - {D}_{y} ( E ( y ) ) ‖}_{2}^{2} + {‖ z - {D}_{z} ( E ( z ) ) ‖}_{2}^{2} \qquad ( Eq . 13 )$$

$${L}_{adv} = {‖ Dis ( E ( y ) ) - 0.5 ‖}_{2}^{2} + {‖ Dis ( E ( z ) ) - 0.5 ‖}_{2}^{2} \qquad ( Eq . 14 )$$

Using the total loss (defined as Lₜₒₜₐₗ=L_{rec}+λ_{adv}L_{adv}), the encoder E (e.g., 310) can be trained to extract a shared and aligned feature domain from the two LR domains (e.g., real-world LR and known LR domains) to perform domain adaptation, while the reconstruction loss 316a-316b can ensure that the feature domain preserves enough information, and the decoders D_{y} and D_{z} can restore the input LR images. The discriminator Dis (e.g., 314) can be trained using an adversarial loss 318 to compete with the encoder 310 and decoders 312a-312b, as shown in Equation 15, to distinguish the features 320a and 320b from different LR domains.

$${L}_{dis} = {‖ Dis ( E ( y ) ) - 1 ‖}_{2}^{2} + {‖ Dis ( E ( z ) ) - 0 ‖}_{2}^{2} \qquad ( Eq . 15 )$$

After training, the encoder E (e.g., 310) and the decoder D_{y} (e.g., 312a) are configured to convert z into the known LR domain, enabling subsequent super-resolution via DPS using the updated CD-DPS score function, as shown in Equation 16.

$${∇}_{{x}_{t}} log {p}_{t} ( {x}_{t} \vert z ) ≃ {ϵ}_{θ} ( {x}_{t} , c , t ) - \frac{1}{{σ}^{2}} {∇}_{{x}_{t}} {‖ {D}_{y} ( E ( z ) ) - A ( {\hat{x}}_{0} ( {x}_{t} ) ) ‖}_{2}^{2} \qquad ( Eq . 16 )$$

By applying ancestral sampling steps, Equation 16 yields a CD-DPS process. FIG. 3C shows an example algorithmic implementation of the CD-DPS process in the exemplary system, in accordance with an illustrative embodiment.

### Example Artificial Intelligence (AI) and Machine Learning (ML) Models

Machine Learning. In addition to the machine learning features described above, the exemplary system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include, but are not limited to, artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by down-sampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

Other Unsupervised Learning Models. Beyond models like the k-NN classifier, dimensionality reduction approaches such as principal component analysis (PCA) map the high-dimensional data into a low-dimensional space to remove redundant features and preserve informative features. Generative models such as generative adversarial networks (GANs) enable unsupervised training and the generation of samples from the training data distribution. Models like Cycle-GAN achieved image-to-image translation tasks using unpaired data training.

### Example Generalizable Trained AI Model Applications

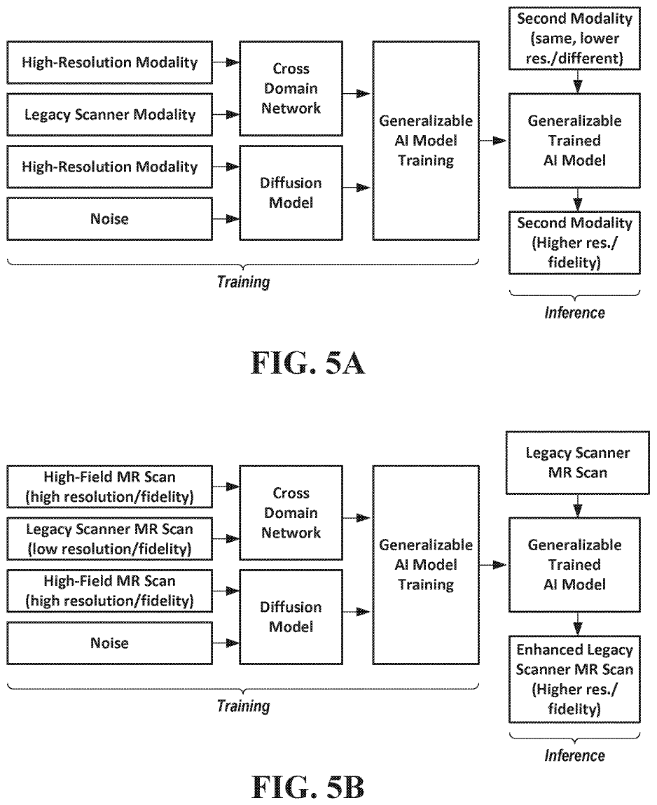

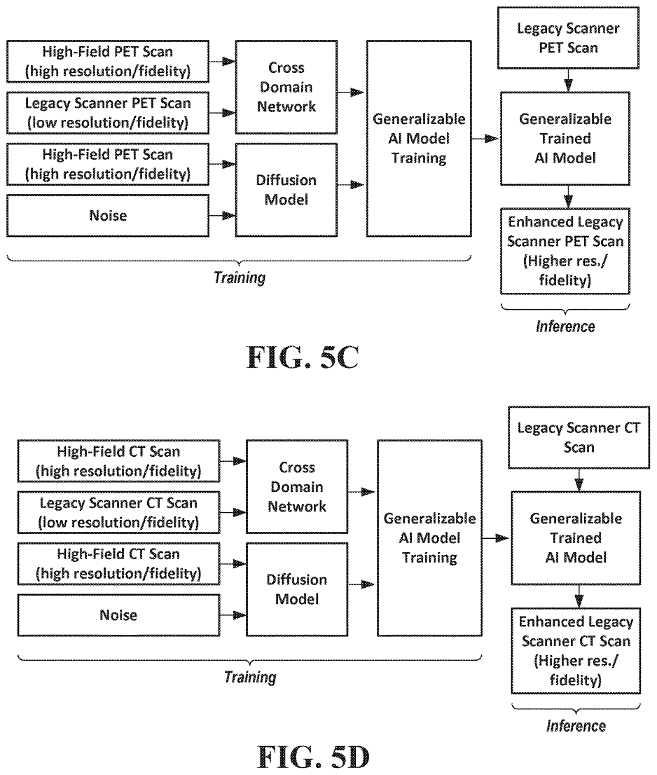

FIGS. 5A-5D each show an example system having a generalizable trained artificial intelligence (AI) model configured to generate a super-resolution or improved image using an initial image acquired from a legacy scanner, in accordance with an illustrative embodiment.

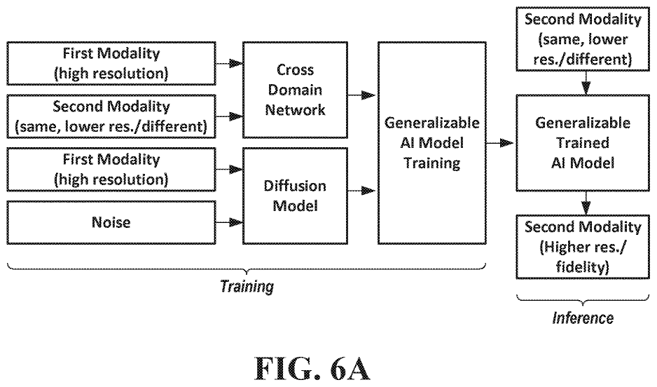

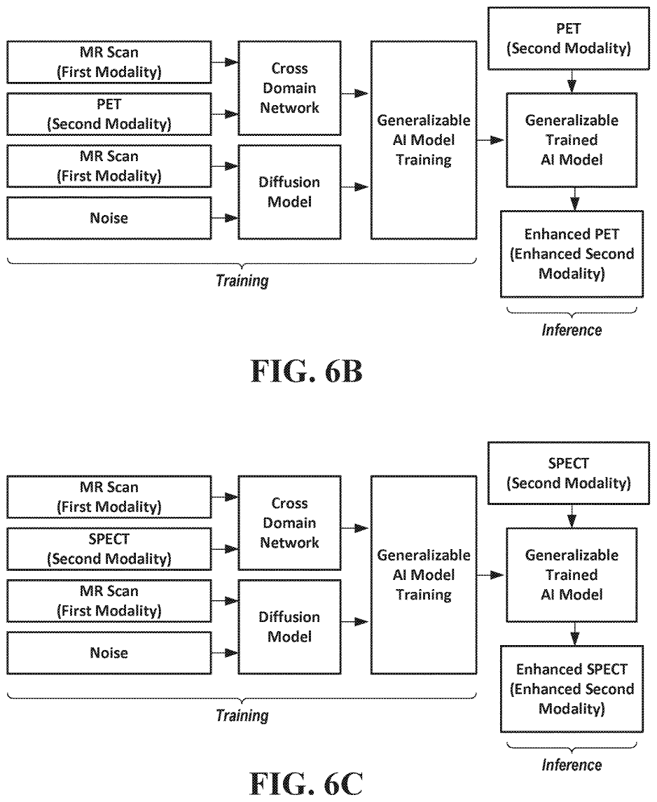

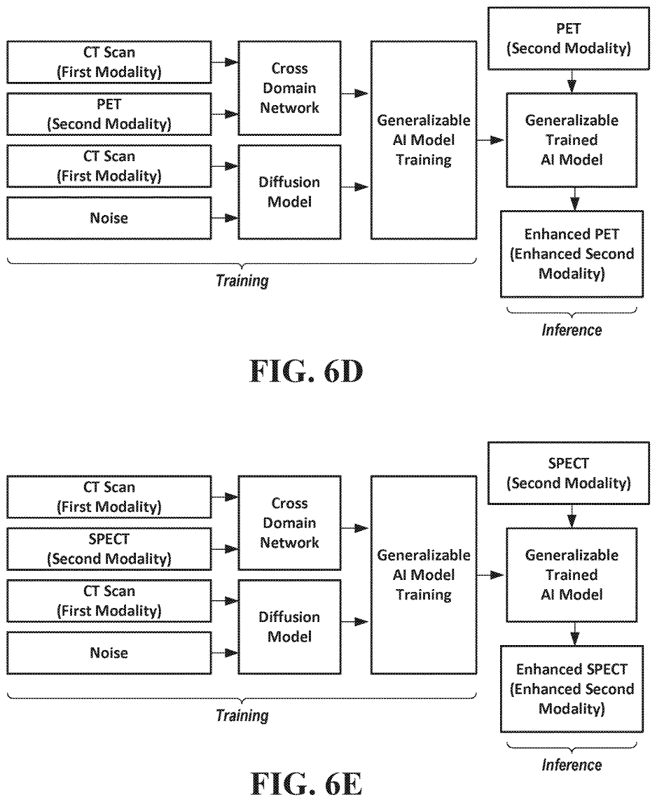

FIGS. 6A-6F each show an example system having a generalizable trained artificial intelligence (AI) model configured to generate an improved image using cross-domain training from another modality, in accordance with an illustrative embodiment.

Legacy Scanners. Hospitals have large data stores of PET, CT, and MRI images acquired from old legacy PET, MR, and CT scanners, where the images were acquired as low-resolution images or with poor quality images. The generalizable trained artificial intelligence (AI) model, e.g., as described in relation to FIGS. 1A and 1B, can be used to reprocess the low-resolution images or poor-quality images to provide improved or enhanced resolution or quality images. The improved or enhanced resolution or quality images can be used in clinical applications, e.g., allowing for better comparison of a current PET, MR, or CT study to historical ones, where the historical data set for the same patient has been improved or enhanced.

In some embodiments, the improved or enhanced processing operation can be used to generate improved or enhanced resolution or quality images, as a new training dataset, that can be used for AI training. Indeed, hospitals have big populations of images that were acquired on legacy scanners from different times, different patients, for which there are no matches. By learning the mapping between the legacy scanners and the new scans, existing data from hospitals that are blurry and low quality can be harmonized for use with data acquired from their new scanners.

FIG. 5B shows a legacy MR scan being enhanced from a high-field MR scan. FIG. 5C shows a PET scan being enhanced from a high-fidelity PET scan. FIG. 5D shows a legacy CT scan being enhanced from high-fidelity CT scans.

Cross-Modality Improvements. CT and MR have high-intensity information with respect to structure compared to functionalized scans such as SPECT and PET. The generalizable trained artificial intelligence (AI) model, e.g., as described in relation to FIGS. 1A and 1B, can be used to reprocess the images from functionalized scans, such as SPECT and PET, to improve or enhance the fidelity of the scans using learned structural features from corresponding CT or MR scans. FIG. 6B shows a PET scan being enhanced from MR scans. FIG. 6C shows a SPECT scan being enhanced from MR scans. FIG. 6D shows a PET scan being enhanced from CT scans. FIG. 6E shows a SPECT scan being enhanced from CT scans.

### EXPERIMENTAL RESULTS AND ADDITIONAL EXAMPLES

A study was conducted to develop and evaluate two generalizable trained artificial intelligence (AI) models (referred to as CD-DPS models), each configured to generate a super-resolution tomography image using a standard tomography image (e.g., of a brain) of a patient, as described in relation to FIGS. 1-3.

Datasets. The study trained and evaluated the two CD-DPS models using ¹⁸F-Flortaucipir tau PET datasets acquired from two PET scanners: a GE Discovery MI (DMI) scanner for HR PET images and a legacy Siemens/CTI EXACT HR+ scanner for LR PET images. Table 1 shows the two PET datasets used to train and evaluate the CD-DPS models.

TABLE 1

| Dataset | Details |
|---|---|
| Paired phantom | The study included 152 tau PET images from 88 subjects from the Alzheimer's |
| simulation dataset | Disease Neuroimaging Initiative (ADNI), a large-scale dataset that provided PET, |
| (also referred to as | MR, and clinical information collected at multiple sites to support research on |
| the DMI dataset) | Alzheimer's disease. The study acquired all PET images using the DMI scanner |
| | with corresponding T1-weighted MPRAGE MR images. The study developed a |
| | phantom generation pipeline to simulate paired HR ground-truth and LR PET |
| | images. The study segmented MR images using FreeSurfer and co-registered the |
| | MR and PET images. The study used DMI PET images to compute average |
| | standardized uptake value ratios (SUVRs) for each region-of-interest (ROI) |
| | labeled jointly with FreeSurfer. The computed SUVRs were assigned to each ROI |
| | to create HR ground-truth (GT) phantom images with less intensity spillover. The |
| | GT phantom was projected into the sinogram space using the geometric model of |
| | the HR+ scanner, with sinogram-domain blurring to simulate LR images. The |
| | sinogram data were then reconstructed using ordered subset expectation |
| | maximization (OSEM) and smoothed using a Gaussian filter to generate realistic |
| | and LR PET images. The study used 84 PET images from 59 subjects as the |
| | target DMI images and 68 PET images from 29 subjects as the HR+ images, |
| | paired with DMI for reference-based evaluation. For all 3D volumes, the study |
| | took 2D coronal slices to train and validate the model. |
| Unpaired clinical | The dataset was derived from a clinical cohort acquired at the Massachusetts |
| dataset | General Hospital. The dataset included 87 subject images from the DMI scanner |
| (also referred to as | and 67 from the HR+ scanner. Both scanning protocols involved image acquisition |
| HR+ datasets) | for a 75 to 105-minute time window after a 370 MBq ¹⁸F-Flortaucipir bolus |
| | injection. PET data were (i) stored in list-mode and reconstructed as 6 × 5-minute |
| | frames using ordered subset expectation maximization (OSEM) (e.g., 4 iterations, |
| | 16 subsets for HR+; and 5 iterations, 16 subsets for DMI) and (ii) smoothed using |
| | a Gaussian filter with a full width at half maximum (FWHM) of 5, 6, and 2 mm for |
| | the HR+, LR DMI, and HR DMI datasets, respectively. All participants also had |
| | T1 MRI scans, which were co-registered with their corresponding PET scans. For |
| | all 3D volumes, the study took 2D transverse slices to train and validate the CD- |
| | DPS model. |

Since the two datasets, the paired phantom simulation dataset and the unpaired clinical dataset, differed in image characteristics, the study trained the CD-DPS models separately on each.

Implementation and Training. In the DPM of each CD-DPS model, the study used 1000 diffusion steps (denoted as T=1000) and a noise-variance schedule βₜ that increased from 1×10⁻⁴ to 0.02. A UNet served as the backbone of the DPM, with a dropout rate of 0.1. The DPM was trained using the Adam optimizer with cosine annealing learning rate scheduling, decreasing from 1×10⁻⁴ to 1×10⁻⁶. The study used an exponential moving average strategy to achieve a stable evaluation model, which was trained for 300,000 steps.

In the cross-domain network of each CD-DPS model, the study used UNet-like structures without skip connections, with the downsample module serving as the encoder and the upsample modules as the decoders. The encoder, decoders, and discriminator of the cross-domain network were trained using the Adam optimizer with a two-stage learning rate scheduling. In the first stage, over 25 epochs, the learning rates remained stable at 1×10⁻⁴ for the encoder and decoders, and 5×10⁻⁵ for the discriminator. In the second stage, until the training ended, the learning rates decayed to 0.

For both the simulation and clinical datasets (see Table 1), the DPM backbones of the CD-DPS models were trained using the entire DMI dataset, and the cross-domain networks were trained unsupervisedly using both the DMI and HR+ datasets.

Evaluation. The study compared each CD-DPS model against five baseline models: (i) a non-deep-learning (non-DL) total variation (TV) penalized deconvolution model, (ii) an SR UNet model trained using paired DMI and simulation LR DMI (referred to as baseline UNet), (iii) an SR U-Net model with a cross-domain network (referred to as CD-UNet), (iv) an SR diffusion model trained using paired DMI and simulation LR DMI (referred to as baseline DPM), and (v) a Cycle-GAN model with domain adaptation (referred to as CycleGAN-DA). The CycleGAN-DA model was trained on both the DMI and HR+ datasets, whereas other DL-based models (e.g., baseline UNet, CD-UNet, baseline DPM) were trained only on the DMI dataset.

The study used both reference-based metrics and reference-free metrics for quantitative evaluation. To evaluate pixel-wise quantitative accuracy, the study used the peak signal-to-noise ratio (PSNR) and the structural similarity index (SSIM), as formulated in Equations 17 and 18, respectively.

$$PSNR = 10 {log}_{10} ( \frac{{MAX}^{2}}{MSE} ) \qquad ( Eq . 17 )$$

$$SSIM ( x , y ) = \frac{( 2 {μ}_{x} {μ}_{y} + {C}_{1} ) ( 2 {σ}_{xy} + {C}_{2} )}{( {μ}_{x}^{2} + {μ}_{y}^{2} + {C}_{1} ) ( {σ}_{x}^{2} + {σ}_{y}^{2} + {C}_{2} )} \qquad ( Eq . 18 )$$

In Equations 17 and 18, MAX denotes the maximum value of a reference (ground-truth) image, MSE denotes the mean square error between a predicted image and the ground-truth image, μₓ and μ_{y} denote the means of the predicted and ground-truth images, respectively,

$${σ}_{x}^{2} and {σ}_{y}^{2}$$

denote the variances of the predicted and ground-truth images, respectively, σ_{xy} denotes the covariance between the two images, and C₁ and C₂ denote constants used to stabilize the division.

PSNR reflects the level of pixel-wise error on a normalized scale, while SSIM focuses on global structural similarity. For generative models, the Frechet inception distance (FID) is a metric that measures visual similarity at the dataset level using the distributional characteristics of features extracted from deep neural networks. Using a pretrained feature extraction network (e.g., an Inception-v3 network producing a Gaussian feature space), denoted as go, FID could be computed per Equation 20.

$${g}_{θ} ( x ) ∼ N ( {μ}_{x} , {μ}_{y} ) , {g}_{θ} ( y ) ∼ N ( {μ}_{y} , {Σ}_{y} ) \qquad ( Eq . 19 )$$

$$FID = {‖ {μ}_{x} - {μ}_{y} ‖}_{2}^{2} + Tr ( {Σ}_{x} + {Σ}_{y} - 2 {( {Σ}_{x} {Σ}_{y} )}^{1 / 2} ) \qquad ( Eq . 20 )$$

For the paired dataset, the study used all four metrics (see Equations 17, 18, 19, and 20) to evaluate the models. For the unpaired dataset, because there was no paired data, the study used FID as an evaluation metric.

Evaluation Results. The study compared the CD-DPS model with baseline models using the paired phantom dataset. Table 2 shows the quantitative results for PSNR, SSIM, and FID among the models.

TABLE 2

| | | | Baseline | Baseline | | | |
|---|---|---|---|---|---|---|---|
| Model | HR+ (LR) | TV | UNet | DPM | CD-UNet | CycleGAN | CD-DPS |
| PSNR | 14.31 | 14.56 | 13.46 | 14.70 | 14.70 | 17.60 | 19.18 |
| SSIM | 0.8880 | 0.8986 | 0.8767 | 0.8548 | 0.9017 | 0.9489 | 0.9646 |
| FID | 192.96 | 179.48 | 242.13 | 247.35 | 184.40 | 41.22 | 13.24 |

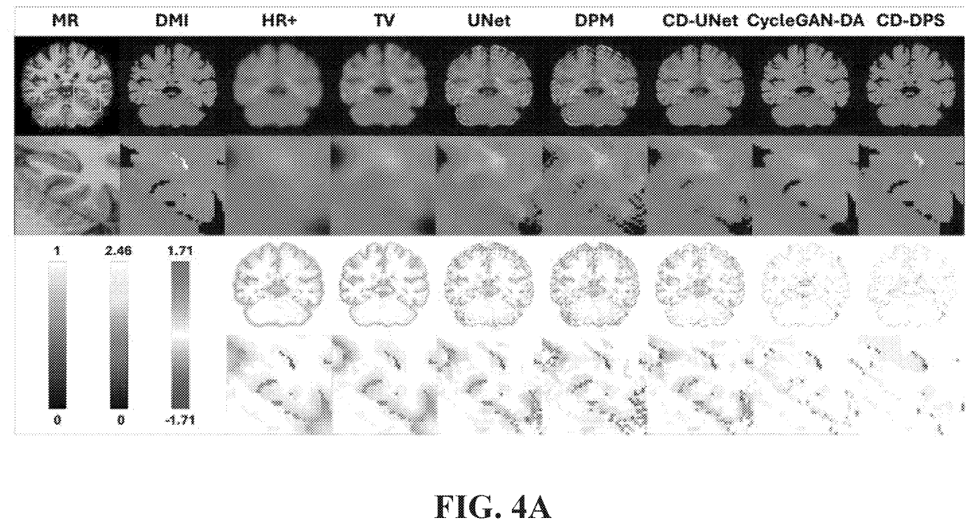

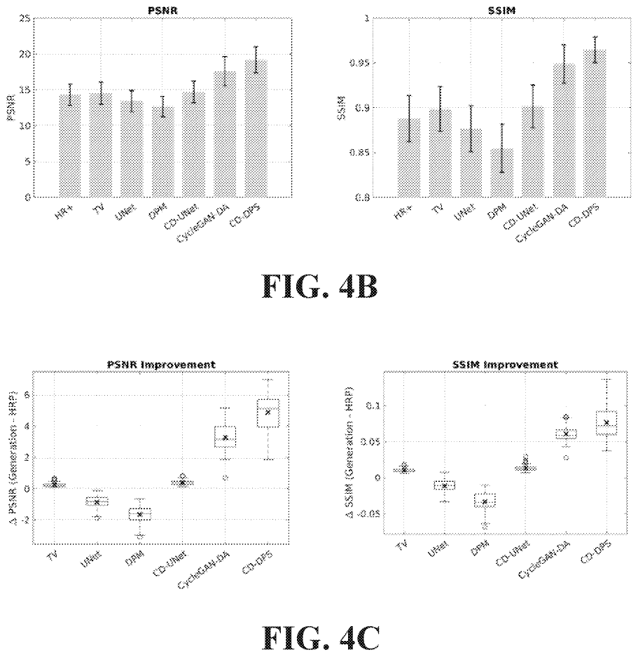

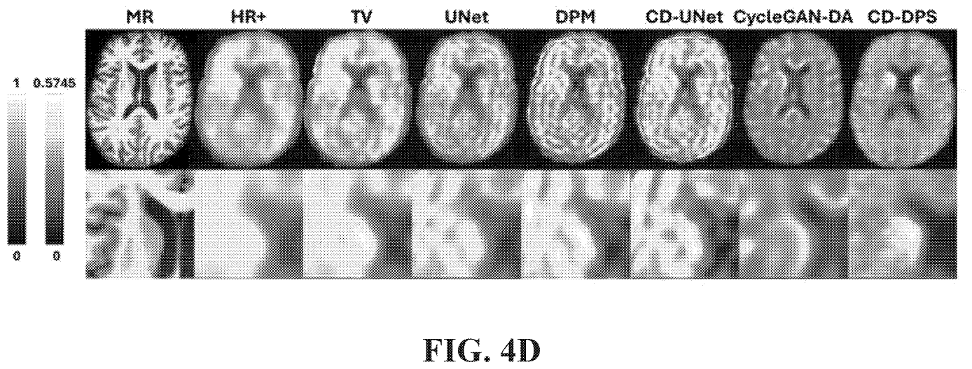

FIG. 4A shows a testing coronal slice in the MR, LR HR+ PET, DMI PET, and SR PET images from all the models. In FIG. 4A, the first row shows full-size coronal slices, the second row shows a zoomed-in region that highlights a small high-intensity region and white-matter boundaries, the third row shows the difference maps between the LR and SR PET images and the ground-truth DMI, and the fourth row shows a zoomed-in view of the difference maps. FIG. 4B shows bar plots of PSNR and SSIM for the CD-DPS model and the baseline models on the HR+ PET and SR PET datasets, with the paired DMI PET images as ground truth.

In Table 2 and FIG. 4B, the CD-DPS model achieved the highest PSNR and SSIM across all methods, indicating its superior ability to restore pixel-to-pixel accuracy. The low FID value of the CD-DPS model indicated the alignment between the SR images and real HR DMI PET images in terms of visual characteristics. In FIG. 4A, the CD-DPS model could produce an SR image with high visual fidelity. Only the CD-DPS model restored the small, high-intensity regions that were blurred in the LR HR+ image, as well as the sharp boundary between gray and white matter. The difference maps between the SR images and the ground-truth DMI image showed that the overall error of the CD-DPS model was compressed. Although the CD-DPS model still showed intensity bias due to the inherent difficulty of the unsupervised SR task, it still improved both the visual quality and quantitative accuracy of the PET image.

FIG. 4C shows box plots of PSNR and SSIM improvements of all the SR models over the HR+ dataset. The baseline UNet model and the baseline DPM, trained in a supervised manner, failed to generalize to the HR+ dataset. The baseline UNet model and the baseline DPM also achieved poor FID and maintained the same level of PSNR and SSIM accuracy as the LR HR+ inputs (see Table 2 and FIG. 4B). In FIG. 4A, due to the domain shift between the simulation blur kernel and the real-world blur effect, the SR images contained obvious artifacts. In the CD-UNet model, the cross-domain network improved the UNet's performance, demonstrating the effectiveness of the cross-domain network for domain transfer. As a non-DL model, the TV model improved PET image contrast, but the gain was minor compared to that of the CD-DPS model (see FIG. 4C). The CycleGAN-DA model achieved good results, but it still fell short of the CD-DPS model. The CycleGAN-DA model was retrained from scratch for each new dataset, and the training/retraining was difficult.

The study also compared the CD-DPS model with baseline models using an unpaired clinical dataset. Table 3 shows the quantitative results for FID among the models. FIG. 4D shows a transverse slice in the MR, LR HR+ PET, and SR PET images from all the models.

TABLE 3

| | HR+ | | Baseline | Baseline | CD- | | CD- |
|---|---|---|---|---|---|---|---|
| Model | (LR) | TV | UNet | DPM | UNet | CycleGAN | DPS |
| FID | 81.72 | 64.49 | 179.06 | 149.07 | 192.40 | 143.95 | 47.29 |

In FIG. 4D and Table 3, on the clinical dataset, the CD-DPS model achieved the highest quantitative performance and produced a high-quality SR image with a style similar to the DMI PET image without compromising the PET information. The artifacts in the SR image from the CD-DPS model were reduced compared to those from the baseline DPM. The cross-domain process improved the result for the CD-UNet model. CD-DPS achieved the lowest FID, indicating its ability to restore SR images with DMI-level quality.

### DISCUSSION

Positron emission tomography (PET) is a quantitative functional imaging modality used in oncology, cardiology, and neurology. A challenge for accurate quantitation in PET is the intrinsically poor spatial resolution caused by various physical degradation factors. Reconstruction regularization and post-reconstruction filtering can further compromise the spatial resolution. This low resolution leads to partial-volume effects, affecting small and heterogeneous structures and posing challenges for early diagnosis and prognosis.

Various models have been developed to address this issue. Some models measure the point spread function (PSF) of the PET scanner within the image reconstruction framework. Various partial-volume correction approaches have also been shown to be useful. Advances in deep learning (DL), including convolutional neural networks (CNNs) and deep generative models such as generative adversarial networks (GANs) and diffusion probabilistic models (DPMs), have inspired emerging efforts of image super-resolution (SR) techniques. SR refers to the process of improving the quality of a low-resolution (LR) image to produce a high-resolution (HR) image. However, an important limitation of these DL-based approaches is that they are trained in a supervised manner, requiring paired LR-HR PET images. This is not feasible for clinical application, as it is difficult to have the same patient undergo multiple PET sessions on different PET scanners. There is a need for unsupervised PET SR approaches.

The cross-domain diffusion posterior (CD-DPS) sampling model for unsupervised PET SR is developed, in the present disclosure, to generate high-quality SR PET images constrained by the DPS framework. The cross-domain network can convert real-world LR PET images with unknown degradation characteristics into synthetic LR PET images with handcrafted degradation kernels. Evaluations have demonstrated that the CD-DPS model can improve spatial resolution and contrast fidelity, demonstrating its clinical value.

### CONCLUSION

The construction and arrangement of the systems and methods, as shown in the various implementations, are illustrative only. Although only a few implementations have been described in detail in this disclosure, many modifications are possible. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special-purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on the designer's choice. All such variations are within the scope of the disclosure. Likewise, software implementations could be accomplished with programming techniques with rule-based logic and other logic to accomplish the various connection steps, processing steps, comparison steps, and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” mean “including but not limited to,” and are not intended to exclude, for example, other additives, components, integers, or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutations of these may not be explicitly disclosed, each is specifically contemplated and described herein, for all methods and systems. This applies to all aspects of this application, including, but not limited to, steps in disclosed methods. Thus, if there are a variety of additional steps that can be performed, it is understood that each of these additional steps can be performed with any specific implementation or combination of implementations of the disclosed methods.

The following patents, applications, and publications, as listed below and throughout this document, are hereby incorporated by reference in their entirety herein.
[1] T.-A. Song, S. R. Chowdhury, F. Yang, and J. Dutta, “PET image superresolution using generative adversarial networks,” Neural Networks, vol. 125, pp. 83-91, 2020.
[2] Z. Zhou, A. Behzadfar, T.-A. Song, M. Malekzadeh, C. L. Gomez, K. A. Johnson, and J. Dutta, “Unsupervised tau pet image super-resolution using domain adaptation,” in 2023 IEEE Nuclear Science Symposium, Medical Imaging Conference and International Symposium on Room-Temperature Semiconductor Detectors (NSS MIC RTSD), 2023, pp. 1-1.
[3] Z. Zhou, T.-A. Song, F. Yang, C. L. Gomez, K. A. Johnson, and J. Dutta, “Super resolution tau PET using a diffusion probabilistic model”. in Journal of Nuclear Medicine June 2024, 65 (supplement 2) 242184, 2024.
[4] H. Chung, J. Kim, M. T. Mccann, M. L. Klasky, and J. C. Ye, “Diffusion posterior sampling for general noisy inverse problems,” 2023.

What is claimed:

1. A system for generating a tomography image of a patient, the system comprising:
a controller comprising:
a processor; and
a memory having instructions stored thereon for a trained AI model comprising a diffusion model and a cross-domain model, wherein execution of the instructions causes the processor to:
receive, via the processor, a tomography image acquired from a first type of scanner; and
apply, via the processor, the received image to the trained AI model comprising the diffusion model and the cross-domain model to generate an output image having image resolution, quality, or scan configuration exceeding that of the received tomography image,
wherein the cross-domain model was trained using a first set of training data, including (i) a set of baseline tomography images acquired from the first type of scanner and (ii) a second set of tomography images derived from a spatially uniform degradation process applied to a high-resolution tomography images acquired from a second type of scanner, wherein the second type of scanner has higher image resolution, image quality, or scan configuration than the first type of scanner, and wherein the diffusion model was separately trained using an unpaired set of high-resolution tomography images as a second set of training data.

2. The system of claim 1, wherein the trained AI model was trained with (i) the set of baseline tomography images being applied to the cross-domain model, (ii) the unpaired set of high-resolution tomography images being applied to the cross-domain model and the diffusion model through a spatially uniform degradation process to provide paired training data to the cross-domain model and the diffusion model.

3. The system of claim 2, wherein the cross-domain model is a cross-domain autoencoder comprising:
an encoder configured to receive the set of tomography images acquired from the first type of scanner and the set of tomography images acquired from the second type of scanner as inputs; and
two or more decoders coupled to the encoder and configured to be separately trained for reconstruction loss and adversarial loss, each decoder being configured to reconstruct the received inputs from the respective first and second types of scanners.

4. The system of claim 1, wherein the tomography image is selected from a group consisting of a positron emission tomography (PET) image, an ultrasound image, a magnetic resonance image (MRI), an X-ray image, and an image with spatial variations in resolution.

5. The system of claim 1, wherein the diffusion model was trained using a pre-trained diffusion model via (i) a forward process that gradually adds noise to a clean image until it becomes pure Gaussian noise and (ii) a reverse sampling process that reverses the forward process to generate clean images from pure noise, the pre-trained diffusion model being regularized with a diffusion posterior sampling (DPS) score function.

6. The system of claim 1, wherein, for cross-domain model training, an original standard image dataset and a degraded high-quality image dataset are both employed so the cross-domain model aligns a standard image domain and a high-quality image domain.

7. The system of claim 1, wherein, for diffusion model training, an original high-quality image dataset and a corresponding paired degraded image dataset are employed.

8. A non-transitory computer-readable medium having instructions stored thereon, wherein execution of the instructions by a processor causes the processor to:
receive, via the processor, a tomography image acquired from a first type of scanner; and
apply, via the processor, the received image to a trained AI model comprising a diffusion model and a cross-domain model to generate an output image having image resolution, quality, or scan configuration exceeding that of the received tomography image,
wherein the cross-domain model was trained using a first set of training data, including (i) a set of baseline tomography images acquired from the first type of scanner and (ii) a second set of tomography images derived from a spatially uniform degradation process applied to a high-resolution tomography images acquired from a second type of scanner, wherein the second type of scanner has higher image resolution, image quality, or scan configuration than the first type of scanner, and wherein the diffusion model was separately trained using an unpaired set of high-resolution tomography images as a second set of training data.

9. The non-transitory computer-readable medium of claim 8, wherein the trained AI model was trained with (i) the set of baseline tomography images being applied to the cross-domain model, (ii) the unpaired set of high-resolution tomography images being applied to the cross-domain model and the diffusion model through a spatially uniform degradation process to provide paired training data to the cross-domain model and the diffusion model.

10. The non-transitory computer-readable medium of claim 9, wherein the cross-domain model is a cross-domain autoencoder comprising:
an encoder configured to receive the set of tomography images acquired from the first type of scanner and the set of tomography images acquired from the second type of scanner as inputs; and
two or more decoders coupled to the encoder and configured to be separately trained for reconstruction loss and adversarial loss, each decoder being configured to reconstruct the received inputs from the respective first and second types of scanners.

11. The non-transitory computer-readable medium of claim 8, wherein the tomography image is selected from a group consisting of a positron emission tomography (PET) image, an ultrasound image, a magnetic resonance image (MRI), an X-ray image, and an image with spatial variations in resolution.

12. The non-transitory computer-readable medium of claim 8, wherein the diffusion model was trained using a pre-trained diffusion model via (i) a forward process that gradually adds noise to a clean image until it becomes pure Gaussian noise and (ii) a reverse sampling process that reverses the forward process to generate clean images from pure noise, the pre-trained diffusion model being regularized with a diffusion posterior sampling (DPS) score function.

13. The non-transitory computer-readable medium of claim 8, wherein, for cross-domain model training, an original standard image dataset and a degraded high-quality image dataset are both employed so the cross-domain model aligns a standard image domain and a high-quality image domain.

14. The non-transitory computer-readable medium of claim 8, wherein, for diffusion model training, an original high-quality image dataset and a corresponding paired degraded image dataset are employed.

15. A method for training an AI model comprising a diffusion model and a cross-domain model, the method comprising:
training the cross-domain model using (i) a set of baseline tomography images being applied to the cross-domain model and (ii) an unpaired set of high-resolution tomography images being applied to the cross-domain model through a spatially uniform degradation process; and
training the diffusion model, wherein the diffusion model was separately trained using the unpaired set of high-resolution tomography images applied to the diffusion model through the spatially uniform degradation process.

16. The method of claim 15, wherein the trained AI model was trained with (i) the set of baseline tomography images being applied to the cross-domain model, (ii) the unpaired set of high-resolution tomography images being applied to the cross-domain model and the diffusion model through a spatially uniform degradation process to provide paired training data to the cross-domain model and the diffusion model.

17. The method of claim 16, wherein the cross-domain model is a cross-domain autoencoder comprising:
an encoder configured to receive the set of tomography images acquired from a first type of scanner and the set of tomography images acquired from a second type of scanner as inputs; and
two or more decoders coupled to the encoder and configured to be separately trained for reconstruction loss and adversarial loss, each decoder being configured to reconstruct the received inputs from the respective first and second types of scanners.

18. The method of claim 15, wherein each tomography image is selected from a group consisting of a positron emission tomography (PET) image, an ultrasound image, a magnetic resonance image (MRI), an X-ray image, and an image with spatial variations in resolution.

19. The method of claim 15, wherein the diffusion model was trained via (i) a forward process that gradually adds noise to a clean image until it becomes pure Gaussian noise and (ii) a reverse sampling process that reverses the forward process to generate clean images from pure noise, the diffusion model being regularized with a diffusion posterior sampling (DPS) score function.

20. The method of claim 15, wherein, for cross-domain model training, an original standard image dataset and a degraded high-quality image dataset are both employed so the cross-domain model aligns a standard image domain and a high-quality image domain.
